(19) United States
(12) Patent Application Publication
(10) Pub. No.: US 2010/0017248 A1
(43) Pub. Date: Jan. 21, 2010

(54) PRODUCT TRACKING AND AUTHENTICATION USING AUTOMATIC IDENTIFICATION

(75) Inventors: Srdjan Boskovic, Walldorf (GE); Wolfram Beck, Hoechst (GE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (GE)

(21) Appl. No.: 12/495,472

(22) Filed: Jun. 30, 2009

Related U.S. Application Data
(60) Provisional application No. 61/081,726, filed on Jul. 17, 2008.

(51) Int. Cl. G06Q 10/00; G06F 19/00

(52) U.S. Cl. 705/8; 235/385; 705/7

(57) ABSTRACT

According to one general aspect, a method may include generating a transfer order within a planning system. In some embodiments, the transfer order may include instruction for the transfer of at least one physical object from at least a first location to a second location and an expected transfer time. In various embodiments, the method may include automatically communicating at least part of the information included in the transfer order to an execution system. In some embodiments, the method may include monitoring, via the execution system, the movement of the physical objects via tags, wherein each tag is associated with one of the physical objects. In one embodiment, the method may include automatically communicating movement information regarding the movement of the physical object(s) to the planning system.

### CROSS-REFERENCE TO RELATED APPLICATION

This application claims priority under 35 U.S.C. §119 to U.S. Patent Application 61/081,726, filed Jul. 17, 2008, titled “Product Tracking and Authentication Using Automatic Identification,” which is incorporated herein by reference in its entirety.

### TECHNICAL FIELD

This description relates to tracking of business information and more specifically to the tracking of physical objects within a production environment.

### BACKGROUND

In many production environments and processes, supplying the correct input components to the correct production supply area is crucial to smooth operations and product production. In some cases without automatic identification technologies (e.g., radio-frequency identification (RFID)), human efforts and interaction are required to control and manage the movements of components, especially in large plants. Value Chain Violations (e.g., theft) can also occur during internal movements of components. In various embodiments, these internal movements may include movement from the storage area to the production area. In various embodiments, if the missing component is not identified within sufficient time, the production process may be adversely affected.

Enterprise resource planning (ERP) is typically the planning of how business resources (e.g., inventory, employees, customers, etc.) are acquired and flow through the business process associated with each resource. Frequently, ERP includes the capture, storage and analysis of information relating to the tracked resources. In various cases ERP may be divided into sub-categories or systems pertaining to financials, human capital management, materials management, customer relationship management, sales & distribution, and production planning, corporate services, and/or general operations management. In general, a well executed ERP system enhances productivity and provides insight to a business. Often an ERP customer may wish to keep their ERP data secret from their competitors and more generally the world.

### SUMMARY

According to one general aspect, a method may include generating a transfer order within a planning system. In some embodiments, the transfer order may include instruction for the transfer of at least one physical object from at least a first location to a second location and an expected transfer time. In various embodiments, the method may include automatically communicating at least part of the information included in the transfer order to an execution system. In some embodiments, the method may include monitoring, via the execution system, the movement of the physical objects via tags, wherein each tag is associated with one of the physical objects. In one embodiment, the method may include automatically communicating movement information regarding the movement of the physical object(s) to the planning system.

According to another general aspect, a system comprising a planning system device or apparatus and an execution system device or apparatus. In various embodiments, the planning system device may be configured to generate a transfer order, wherein the transfer order includes instructions for the transfer of at least one physical object from at least a first location to a second location and an expected transfer time, and automatically communicate at least part of the information included in the transfer order to an execution system device. In one embodiment, the execution system device configured to monitor the movement of the physical objects via tags, wherein each tag is associated with one of the physical objects, and automatically communicate movement information regarding the movement of the physical object(s) to the planning system.

According to another general aspect, a computer program product for managing business information may include executable code that, when executed, is configured to cause a planning apparatus to generate a transfer order, wherein the transfer order includes instructions for the transfer of at least one physical object from at least a first location to a second location and an expected transfer time. In some embodiments, the code may cause the apparatus to automatically communicate at least part of the information included in the transfer order to an execution system. In various embodiments, the code may cause the apparatus to cause the execution system to monitor the movement of the physical objects via tags, wherein each tag is associated with one of the physical objects. In one embodiment, the code may cause the apparatus to cause the execution system to automatically to communicate movement information regarding the movement of the physical object(s) to the planning system. In various embodiments, the computer program product may be tangibly embodied on a computer-readable medium.

The details of one or more implementations are set forth in the accompanying drawings and the description below. Other features will be apparent from the description and drawings, and from the claims.

A system and/or method for managing information, substantially as shown in and/or described in connection with at least one of the figures, as set forth more completely in the claims.

### BRIEF DESCRIPTION OF THE DRAWINGS

FIG. 1 is a block diagram of an example embodiment of a system or pair of apparatuses in accordance with the disclosed subject matter.

FIG. 2 is a block diagram of an example embodiment of a system in accordance with the disclosed subject matter.

FIG. 3 is a block diagram of an example embodiment of a system in accordance with the disclosed subject matter.

FIG. 4 is a series of block diagrams of an example embodiment of a user interface in accordance with the disclosed subject matter.

FIG. 5 is a flow chart of an example embodiment of a technique in accordance with the disclosed subject matter.

Like reference symbols in the various drawings indicate like elements.

### DETAILED DESCRIPTION

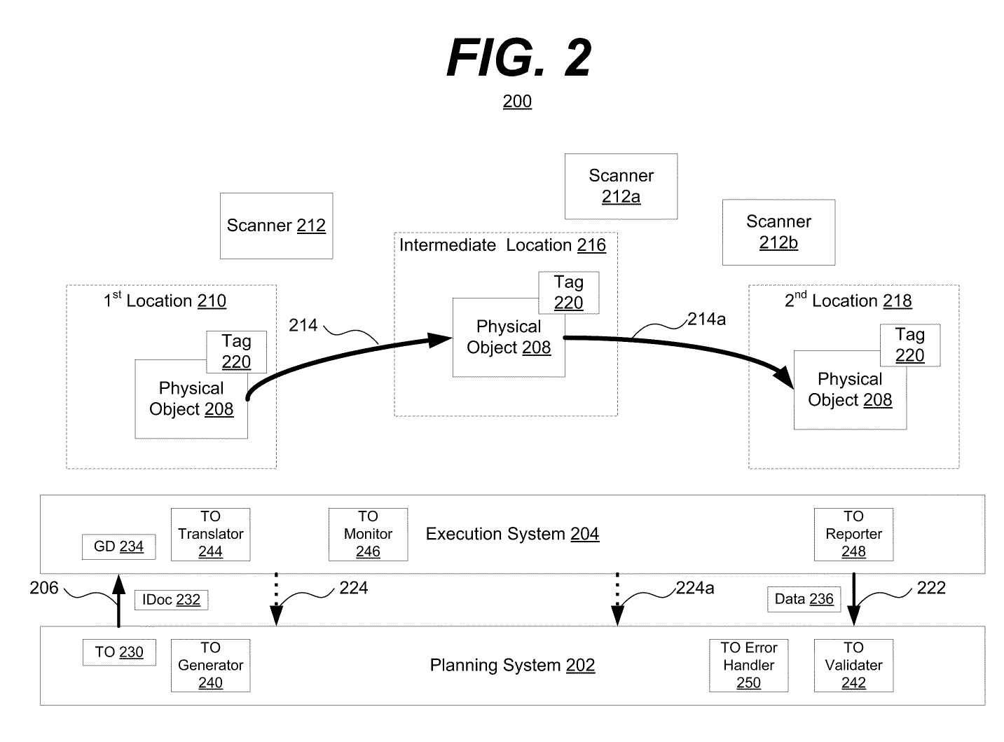

FIG. 2 is a block diagram of an example embodiment of a system 200 in accordance with the disclosed subject matter. In one embodiment, the system 200 may include a planning system 202, and an execution system 204. In various embodiments, the system 200 may be configured to track or monitor the movement of at least one physical object 208 under the direct control of the execution system 204.

In various embodiments, the planning system 202 may include a central office planning system, such as, for example, ERP, as described above, or Enterprise Central Component (ECC), etc.; although, it is understood that the above are merely a few illustrative examples to which the disclosed subject matter is not limited. In one embodiment, the planning system 202 may be configured to allow a centralized planner to manage and control what resources (e.g., capitol and labor, etc.) are needed or desired to manufacture or produce various goods or services.

In various embodiments, the planning system 202 may be configured to provide a high-level view of a manufacturing or other business process. For example, in some embodiments, the planning system 202 may be configured to determine how much raw materials, works-in-process, sub-components, or inventory, etc. may be used or desired in order to create or manufacture a given good or service. In various embodiments, the planning system 202 may be linked or in communication with other business management systems (e.g., a Customer Relationship Management (CRM), Supplier Relationship Management (SRM), Product Lifecycle Management (PLM), Supply Chain Management (SCM), etc.). In various embodiments, one or more of these business management systems may be integrated with the planning system 202.

In various embodiments, the execution system 204 may be configured to provide a low-level view of a manufacturing or other business process. For example, the execution system 204 may be configured to determine, for example, where a physical object is, how much of the physical object exists, the state of a work-in-process good or service, generally manage a supply chain and/or manufacturing or service processes, etc. In various embodiments, the execution system 204 may include an Automated-Identification (Auto-ID) Interface (All) system.

While the disclosed subject matter is generally referred to and described in relation to a context that includes the manufacturing of goods, it is understood that such is merely an illustrative example to which the disclosed subject matter is not limited. For example, a services company may make use of such a system to management which services have been performed or are being performed. Specific examples may include the shipping or movement of parcels or the testing of various biological specimens; although, it is understood that the above are merely a few illustrative examples to which the disclosed subject matter is not limited.

In various embodiments, the planning system 202 may be configured to generate a transfer order (TO) 230. In various embodiments, the transfer order 230 may include information detailing how many of a physical object 208 are to be moved from a first or source location 210 to a second or destination location 218. For example, the planning system 202 may notice that, in order to build or manufacture 100 cell phones, 95 cell phone screens need 208 to be moved from their storage location 210 to the manufacturing floor and more specifically to the screen assembly machine or station 218. In such an embodiment, the planning system 292 may generate a transfer order 230 instructing the execution system 204 to move the 95 cell phone screens 208 accordingly. It is understood that the above are merely a few illustrative examples to which the disclosed subject matter is not limited.

In some embodiments, the planning system 202 may be configured to automatically communicate 206 the information included by the transfer order 230 to the execution system 204. In various embodiments, this communication 206 may be manually initiated, but the formatting and transfer of the information may occur automatically. For example, in one embodiment, the planning system 202 may determine that the transfer order 230 is needed or desirable and ask a user for confirmation before performing the communication 206.

In some embodiments, the communication 206 may occur in an asynchronous fashion. For example, in various embodiments, the timing of the communication 206 may be not need to occur “in real time”. In various embodiments, the communication 206 may include the use or occur via a message formatted in a way substantially compatible with the IDOC 232 standard.

In various embodiments, an IDOC 232 may include a table-based structured data exchange message that includes metadata (e.g., a control record, at least one status record) and at least one data record. In another embodiment, an Extensible Markup Language (XML) document which makes use of tag-based structured data may be employed. In various embodiments, other forms of data exchange may be employed. It is understood that the above are merely a few illustrative examples to which the disclosed subject matter is not limited.

In various embodiments, the communication 206 may include or be conducted via a synchronous communication scheme. or, in another embodiment, a communication scheme that includes both synchronous and asynchronous portions or elements. It is understood that IDoc is merely one non-limiting possibility. In various embodiments, other forms of communication 206 may include a remote function call (RFC), or web communication channel or format, etc.; although, it is understood that the above are merely a few illustrative examples to which the disclosed subject matter is not limited.

In some embodiments, upon receipt or in response to the receipt of the communication 206 the execution system 204 may be configured to create or update a execution system 204-centric document 234 that includes at least a sub-set of the information included in the transfer order 230. In various embodiments, the execution system 204-centric document 234 may take the form of a generic document 234 that is configured to act as a data contained for a plurality of documents or orders. In such an embodiment, a transfer order-based generic document 234 may include a sub-set of fields that are relevant to the movement of goods or services, as described above. It is understood that the above are merely a few illustrative examples to which the disclosed subject matter is not limited.

In various embodiments, the transfer order 230 or information thereof, may cause a plurality of generic documents 234 to be created. For example, in one embodiment, a transfer order 230 may indicate that 50 cell phone screens be moved from the 1^{st} Street warehouse and 45 cell phone screens be moved from the 5^{th} Street warehouse, both to the manufacturing plant on 10^{th} Street. In such an embodiment, the execution system 204 may generate two generic documents 234, one for each of the two sets of cell phone screens. In various embodiments, multiple generic documents 234 may be created by the execution system 204 as fits the execution system's 204 configuration or needs. It is understood that the above are merely a few illustrative examples to which the disclosed subject matter is not limited.

In various embodiments, the execution system 204 may be configured to, based at least in part on the transfer order/generic document 234, cause the physical object(s) 208 indicated by the transfer order/generic document 234 to be moved from their first or current location 210 to their final or second location 218. In various embodiments, this movement may be automated, manual, or a combination thereof.

In one embodiment, the physical object 208 (e.g., cell phone screens) may include or be coupled with a tag 220 or other trackable element or component. In various embodiments, this tag 220 may include, for example, a bar code, recognizable optical pattern, RFID tag, etc.; although, it is understood that the above are merely a few illustrative examples to which the disclosed subject matter is not limited. In addition to the trackable element, the physical object may be also coupled with or include another element or “tag” configured to prove the authenticity of the physical object. Examples of such authentication elements may include holographic patterns, copy-detection patterns or laser surface authentication areas, etc.; although, it is understood that the above are merely a few illustrative examples to which the disclosed subject matter is not limited.

In various embodiments, these tag or tags 220 may be embedded into a physical object 208. For example, the tag 220 may be installed underneath or within the physical object or, in a specific embodiment, the cell phone screen's 208 layer. In some embodiments, the tag 220 may be installed in or to the physical object 208 in a way that the tag 220 is difficult to remove or tamper with.

In such an embodiment, the tag 220 may be employed or used to authenticate the physical object 208. In another embodiment, the tag 220 may have been installed in the physical object 208 by someone further up the supply chain (e.g., the original manufacturer or supplier of the physical object 208). Similarly, in various embodiments, these tags 220 may be employed or used to authentic the genuineness of the physical object 208. For example, a counterfeiter or supplier may provide parts or physical objects 208 allegedly from a certain manufacturer or of a certain quality (e.g., Intel microprocessors rated at 2 GHz, etc.). However, the tag 220 may indicate that the physical object 208 is counterfeit or of a different quality (e.g., an Intel microprocessor rated at 1 GHz, etc.). In such an embodiment, the execution system 204 may cause an error handling scheme to be invoked, as described below.

In various embodiments, as the physical object 208 is moved 214 or at other predefined points or events, the physical object 208 may be scanned or otherwise identified by a scanner 212 or similar device. In one embodiment, the scanner 212 may be configured to read or scan the tag 220 associated with or coupled with the physical object 208. In various embodiments, the scanner 212 may be a fixed, either permanently or semi-permanently, (e.g., a scanner gate, doorway scanner, mounted scanner, countertop scanner, etc.) or a moveable (e.g., handheld scanner, etc.); although, it is understood that the above are merely a few illustrative examples to which the disclosed subject matter is not limited.

In one embodiment, as the physical object 208 is moved from the first location 210 to another or intermediate location 216, the physical object 208 or the tag 220 may be scanned by the scanner 212. In such an embodiment, a message may be sent to the execution system 204 indicating that the physical object 208 has left the first location 210. In various embodiments, the execution system 204 may be configured to track or monitor the movement of the physical object 208 as it proceeds through the path or steps indicated by the transfer order/generic document 234. In some embodiments, as the physical object 208 is scanned or its status is otherwise updated that execution system 204 may be configured to update the planning system 202 on the status of the physical object 208, as described below.

In various embodiments, the physical object 208 may be moved or pass through a number of intermediate locations 216. In some embodiments, as the physical object 208 is moved 214a from the intermediate location 216 to the second or destination location 218 the physical object 208 or tag 220 may be scanned by scanner 212a. Scanner 212b illustrates that, in some embodiments, the physical object 208 or tag 220 may be scanned at arrival as well as at departure from a location. In various embodiments, the physical object 208 or tag 220 may be scanned or read as a result of other events or causes and it is understood that the above are merely a few illustrative examples to which the disclosed subject matter is not limited.

In various embodiments, once the transfer order/generic document 234 has been completed by the execution system 204, a message 236 may be communicated 222 to the planning system 202. As described above, messages may also be communicated 224a to the planning system 202 at various other points.

In one embodiment, the communication 222 between the execution system 204 and the planning system 202 may occur in a synchronous fashion. In various embodiments, the planning system 202 may desire immediate information regarding the transfer order 230 in real time or in a substantially timely manner. In some embodiments, the communication 222 may occur via a remote procedure or function call (RPC or RFC, respectively).

In various embodiments, the communication 222 may include or be conducted via an asynchronous communication scheme. or, in another embodiment, a communication scheme that includes both synchronous and asynchronous portions or elements. It is understood that a RPC is merely one non-limiting possibility. In various embodiments, other forms of communication 222 may include a document transfer, or web communication channel or format, etc.; although, it is understood that the above are merely a few illustrative examples to which the disclosed subject matter is not limited.

In some embodiments, the completion of the transfer order 230 may initiate another action by the planning system 202, for example. In such an embodiment, the transfer order 230 may be a blocking action that may need to be performed before other actions may occur; although, it is understood that the above is merely one illustrative example to which the disclosed subject matter is not limited.

In various embodiments, the transfer order 230 may include a time component or an expected transfer or completion time. For example, in one embodiment, the planning system 202 may expect or allow for the transfer order 230 to be completed within a given amount of time (e.g., 1 hour, etc.). In various embodiments, if the transfer order 230 is not completed or its completion is not reported 222 by the execution system 204 within that expected completion time, the planning system 202 may initiate an error handling scheme.

For example, in one embodiment, the error handling scheme may include generating a second transfer order to fulfill the goals of the first transfer order 230. In such an embodiment, the planning system 202 may order another 95 cell phone screens be brought from a another location to the destination location 218, to replace the missing or delayed 95 cell phone screens of the first transfer order 230. Although, it is understood that the above is merely one illustrative example to which the disclosed subject matter is not limited.

In another embodiment, the planning system 202 may notify the execution system 204 of the failure to complete the transfer order 230 within the expected time. In some embodiments, the execution system 204 may be aware of this expected transfer or completion time component via the communication 206. In such an embodiment, the execution system 204 may be configured to perform its own error handling scheme. For example, in one embodiment, the execution system may initiate a manual search for the physical objects 208 based upon their last scanned location (e.g., intermediate location 216); although, it is understood that the above is merely one illustrative example to which the disclosed subject matter is not limited.

As described above, in various embodiments, the error handling scheme may be initiated if the physical objects fail to be authenticated or are otherwise found to not be genuine. In various embodiments, other occurrences may also initiate the system 200's error handling schemes. It is understood that the above are merely a few illustrative examples to which the disclosed subject matter is not limited.

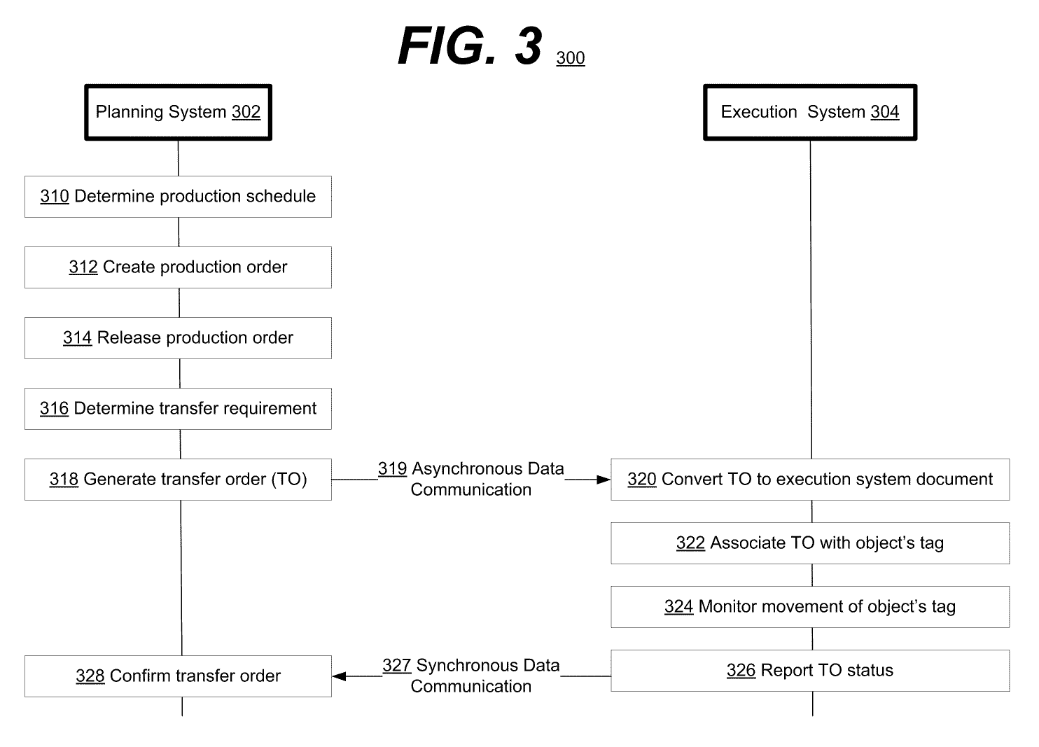

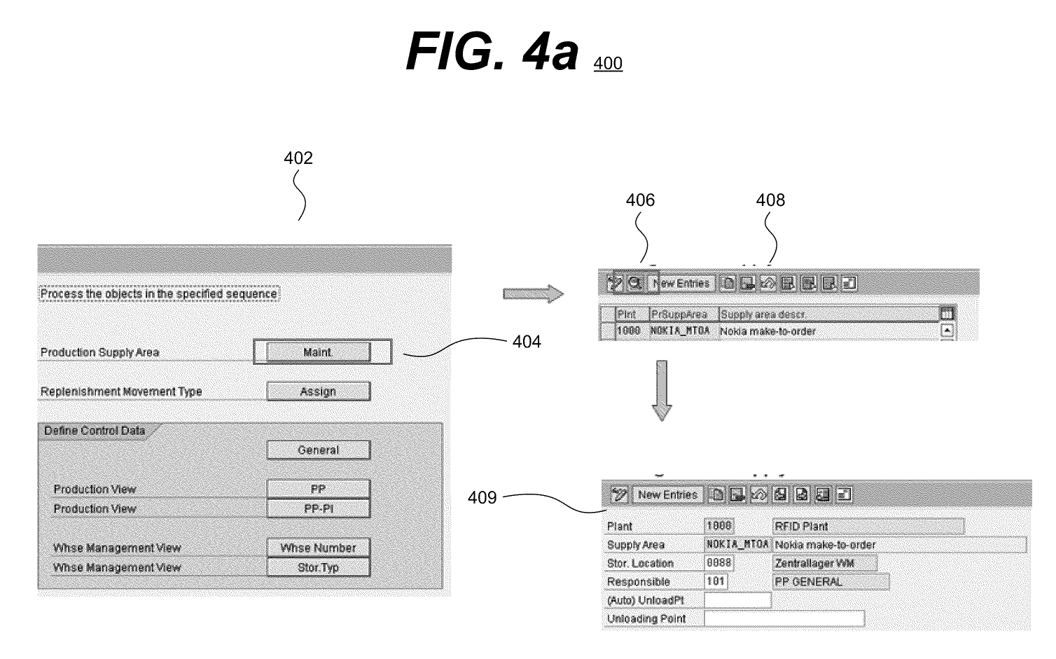

FIG. 3 is a block diagram of an example embodiment of a system 300 in accordance with the disclosed subject matter. In various embodiments, the system 300 may include a planning system 302 and an execution system 304. FIG. 3 illustrates a series of actions performed by the two systems 302 and 304.

Block 310 illustrates that, in one embodiment, the planning system 302 may be configured to determine a production schedule. In various embodiments, the production schedule may dictate or indicate when various production activities (e.g., for the production of a good or service) may occur. In some embodiments, the production schedule may attempt to co-ordinate various activities occurring in a plurality of systems (e.g., ERP, ECC, CRM, SCM, the execution system 304, etc.).

Block 312 illustrates that, in one embodiment, the planning system 302 may be configured to create a production order. In various embodiments, a production order may include a instruction or indication that a given good or service is to be produced. In various embodiments, this production order may relate to an intermediate sub-assembly or good. In some embodiments, the production order may be created in response to a customer request or level of inventory, etc.; although, it is understood that the above are merely a few illustrative examples to which the disclosed subject matter is not limited. In various embodiments, the good or service produced may follow the production schedule, as described above.

Block 314 illustrates that, in one embodiment, the planning system 302 may be configured to release the production order. In various embodiments, the planning system 304 may release or communicate the production order to other systems or into another portion of the planning system 302. In such an embodiment, the production order may not cause the good or service to be produced until the order is released or communicated to the other system or portion of the planning system 302. In another embodiment, the action of Block 314 may not be needed or desired.

Block 316 illustrates that, in one embodiment, the planning system 302 may be configured to determine a transfer requirement. As described above, in various embodiments, the planning system 302 may be configured to determine when and where physical objects should be in order for the production order or the production schedule to be completed or successful. In such an embodiment, the transfer requirement may include information regarding the movement of physical objects between two or more locations. In some embodiments, the transfer requirement may be a requirement that a certain amount of physical objects (e.g., cell phone screens, etc.) be available at a certain location (e.g., the screen assembly area, etc.) at a given time. In various embodiments, the planning system 302 may be configured to determine that goods need to be moved or transferred in order to fulfill the requirement dictated by the production order or production schedule. Likewise, a transfer requirement may pertain to a services-based embodiment.

Block 318 illustrates that, in one embodiment, the planning system 302 may be configured to generate a transfer order (TO). As described above, in various embodiments, the planning system 302 may be configured to determine that goods need to be moved or transferred in order to fulfill the requirement dictated by the production order or production schedule. In such an embodiment, the planning system 302 may generate a transfer order instructing the execution system 304 to move or transfer the goods as required or desired.

As described above, in one embodiment, the transfer order may include instructions for the transfer of at least one physical object from at least a first location to a second location. In some embodiments, the transfer order may also include an expected transfer or completion time that indicates the amount of time the planning system 302 expects to occur before the transfer order is completed. In another embodiment, the expected transfer time may include the amount of time before the transfer order enters an error state, indicating that something is wrong with the transfer order. In various embodiments, after this expected transfer or completion time has expired, the planning system 302 may initiate an error handling scheme, as described above.

Arrow 319 illustrates that, in one embodiment, the transfer order or at least a portion of the information included by the transfer order may be automatically communicated to the executing system 304, as described above. In various embodiments, this communication may occur in an asynchronous manner. In some embodiments, the communication may include the creation and transfer of an IDOC formatted message of document, as described above.

Block 320 illustrates that, in one embodiment, the execution system 304 may be configured to convert the transfer order (or at least the portion of the transfer order communicated to the execution system 304) to an execution system 304 document. As described above, in various embodiments, the execution system 304 may be configured to process or handle documents or information packets in a different format than the planning system 302. In such an embodiment, the execution system 304 may be configured to convert or re-format the received information in to a more useable, for the execution system's 304 point of view, format. In some embodiments, this may include reformatting the received information into a generic document, as described above.

Block 322 illustrates that, in one embodiment, the transfer order (or the execution system's 304 version thereof) may be associated with an item or physical object's tag, as described above. In some embodiments, the tag or tags may not become associated with the transfer order until the physical object is first scanned or identified. In another embodiment, the execution system 304 may associate the tag or physical object with the transfer order before the physical object is first moved.

Block 324 illustrates that, in one embodiment, the execution system 304 may be configured to monitor the movement of the object or the object's tag, as described above. In various embodiments, this may include automatically or manually scanning or reading the object's tag, as described above. In various embodiments, this may also include communicating status information or other information to the planning system 302 as the object is moved.

Block 326 illustrates that, in one embodiment, the execution system 304 may be configured to report the status of the transfer order (or the execution system's 304 version thereof) back to the planning system 302. Arrow 327 illustrates that, in one embodiment, the execution system 304 may communicate the status information of the planning system 302. In one embodiment, this information may be communicated in a synchronous manner.

In various embodiments, the execution system 304 may use or employ a remote procedure or function call to directly report the status of the transfer order to the planning system 302. In some embodiments, reporting the status may include reporting a successfully completed transfer order. In another embodiment, reporting the status may include reporting a partially successful, a partially failed, or a failed transfer order operation or process, as described above.

In some embodiments, the status may involve the authenticity of the physical objects, as described above. In another embodiment, the status may involve the timing or expected transfer or completion time associated with or included in the transfer order, as described above. Although, it is understood that the above are merely a few illustrative examples to which the disclosed subject matter is not limited.

Block 328 illustrates that, in one embodiment, the planning system 302 may be configured to confirm the status of the transfer order. In this context, such a confirm may include checking the reported status of the transfer order versus to the expected outcome of the transfer order. For example, if the transfer order instructed 95 cell phone screens to be transferred to the assembly floor, and only 90 were actually transferred, as reported by the execution system 304, the planning system 302 may note that 5 more cell phone screens are needed or desired. In various embodiments, a short-fall or variance in the actual execution of the transfer order may be acceptable and merely noted by the planning system 302. For example, the planning system 302 may note the short-fall of 5 cell phone screens and in the next transfer order may simply instruct the execution system 304 to move 5 move screen than normal (e.g., 100 screens vs. 95 screens, etc.). Although, it is understood that the above are merely a few illustrative examples to which the disclosed subject matter is not limited.

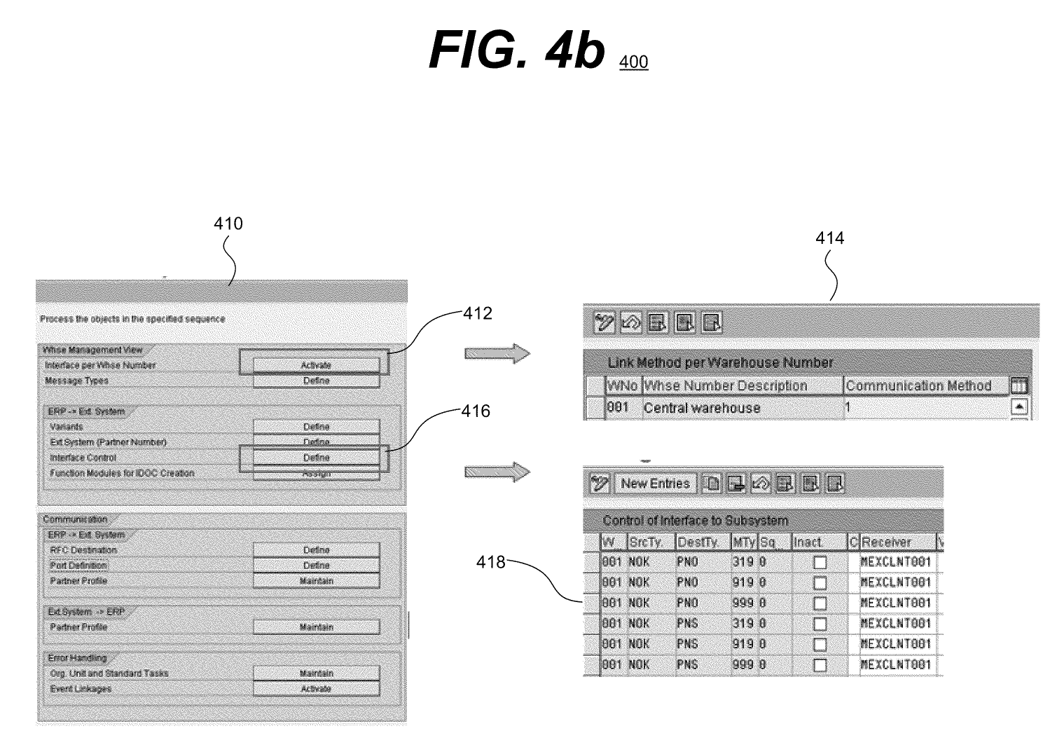

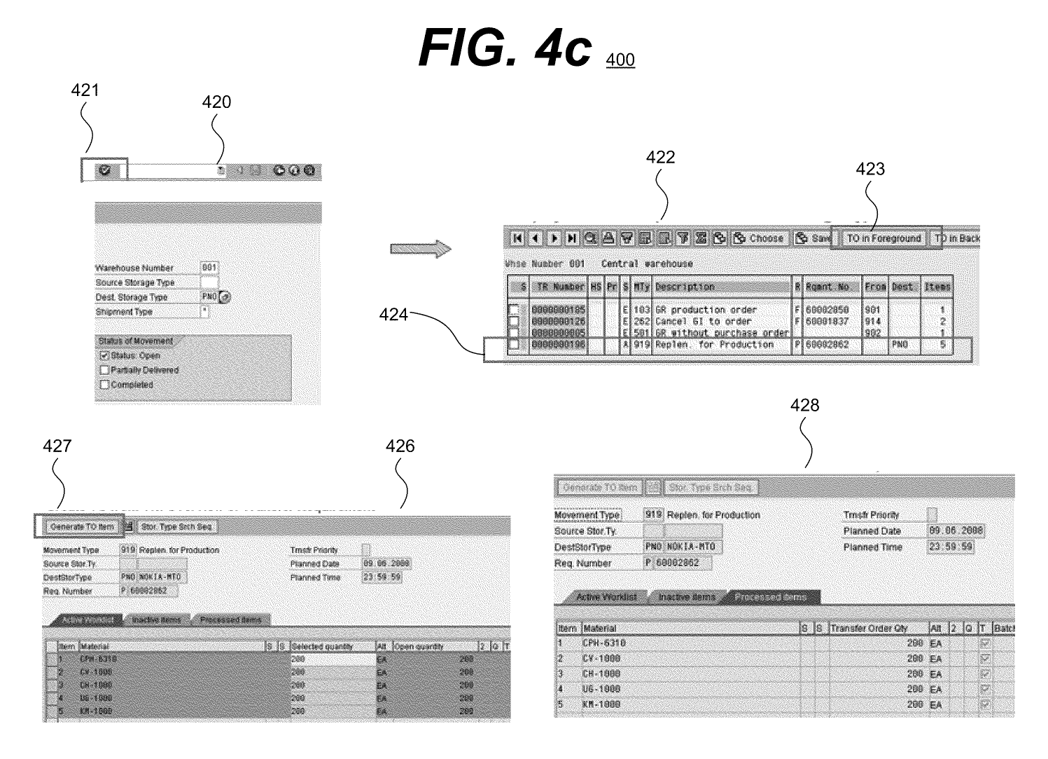

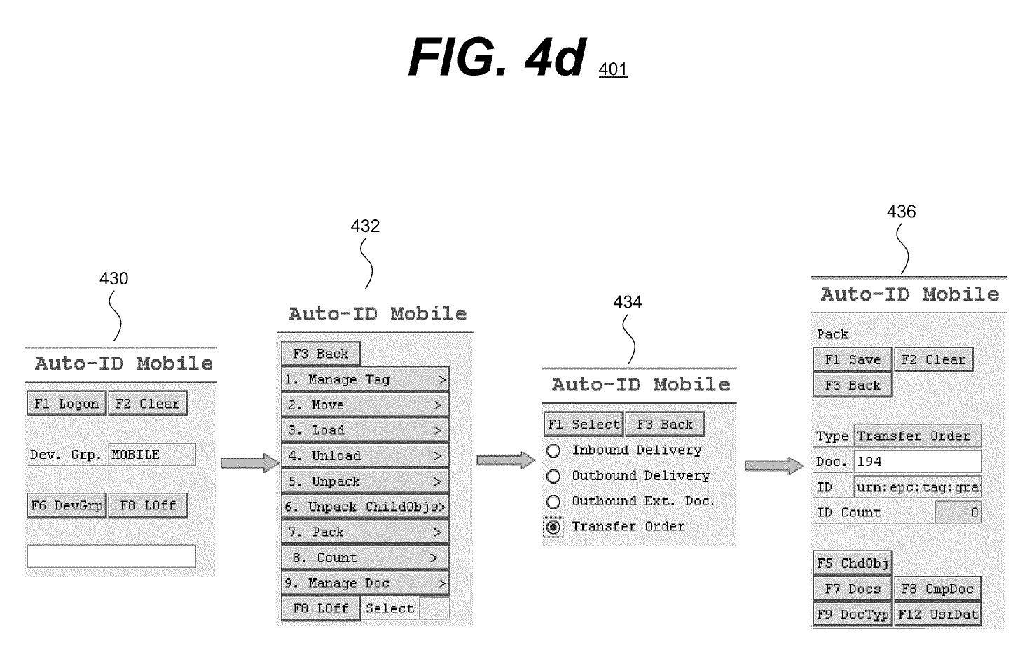

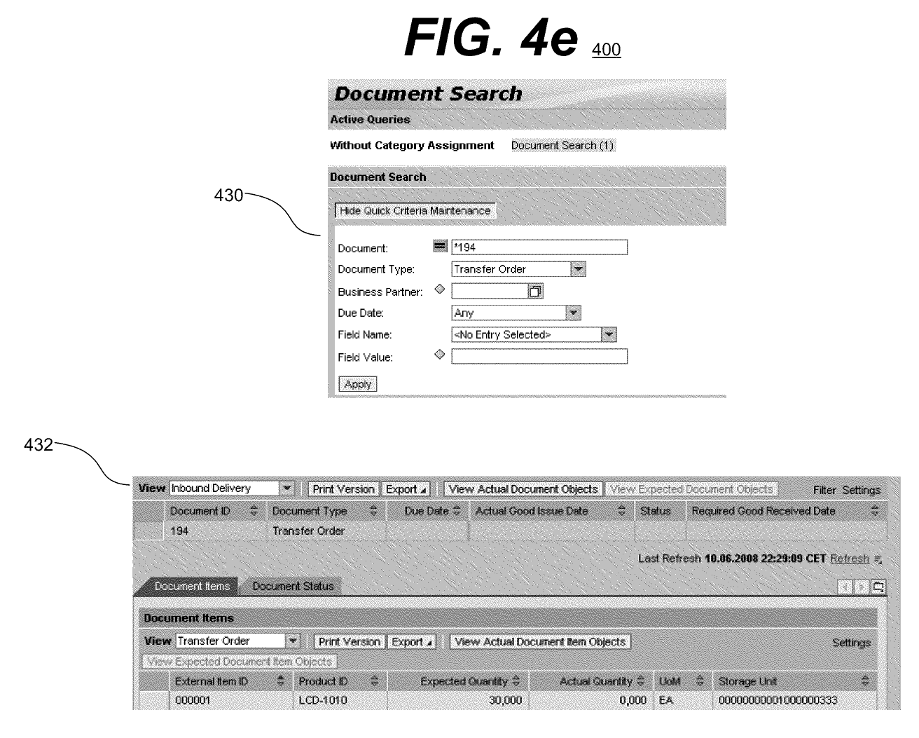

FIG. 4 is a series of block diagrams of an example embodiment of a user interface (UI) 400 in accordance with the disclosed subject matter.

FIG. 4a is block diagrams of an example embodiment of a user interface of the planning system in which a user or administrator may configure or customize warehouse management and define production transactions, which may feed into or define production orders or transfer orders. In one embodiment, the UI 400 may include a screen or UI element 402 configured to facilitate the definition or customization of the production process. In some embodiments, this UI element 402 may include a button or UI element 404 configured to allow a user to define a production supply area.

In various embodiments, the button of UI element 404 may be configured to display a screen or UI element 408. In some embodiments, the screen or UI element 408 may be configured to display a list of supply areas or first locations at which various materials may be stored. For example, in one embodiment, the cell phone screens may be stored in the particular illustrated supply area.

In some embodiments, the screen or UI element 408 may include a button or UI element 406 configured to display a screen or UI element 409. In some embodiments, screen or UI element 409 may provide a group of UI elements that allow a user to define and/or change the definitions and descriptions of the selected supply area of screen or UI element 408.

FIG. 4b is block diagrams of an example embodiment of a user interface of the planning system in which a user or administrator may configure or customize warehouse management and/or warehouse control units or entries. In various embodiments, the UI 400 may include a screen of UI element 410 configured to facilitate the linking of the planning system with an external system (e.g., the execution system, etc.). In one embodiment, the screen or UI element 410 may include a button or UI element 412. In some embodiments, the screen of UI element 410 may include a second button or UI element 416.

In various embodiments, the button or UI element 412 may be configured to display the screen or UI element 414. In one embodiment, the screen or UI element 414 may be configured to allow a user to manage the way, format, protocol, or interface used to communicate with an execution system at a given site (e.g., a warehouse). In various embodiments, the screen 414 may be configured to facilitate the assignment of a human understandable name to the execution system and a method of communication with that system. In various embodiments, the method of communication may be selectable from a list of possible communication schemes.

In various embodiments, the button or UI element 416 may be configured to display the screen or UI element 418. In one embodiment, the screen or UI element 418 may be configured to allow a user to manage the interface between the planning system and execution system at a low level. In one embodiment, the screen or UI element 418 may be configured to map fields and values used or employed by the planning system to fields or values used or employed by the execution system.

FIG. 4c is block diagrams of an example embodiment of a user interface of the planning system in which a user or administrator may generate or create a transfer order via or from a transfer requirement. In various embodiments, the UI 400 may include a screen of UI element 420 configured to facilitate the selection or filtering of transfer requirements. In one embodiment, the screen or UI element 420 may include a button or UI element 421.

In various embodiments, the button or UI element 421 may be configured to display a screen or UI element 422. In one embodiment, the screen or UI element 422 may be configured to display a list of transfer requirements associated with a particular site or external system (e.g., an execution system). In various embodiments, a particular transfer requirement 424 may be selected. In one embodiment, the button of UI element 423 may be selected to display more detail about transfer order(s) associated with the selected transfer requirement 424.

In one embodiment, the screen or UI element 426 may be configured to allow a user to edit or create a transfer order. In various embodiments, the button or UI element 427 may be configured to generate the proposed transfer order. In various embodiments, this may display the screen or UI element 428 which is configured to display the created transfer order.

FIG. 4d is block diagrams of an example embodiment of a user interface 401 of the execution system in which a user may input or scan data related to a transfer order. In one embodiment, the UI 401 may be part of an Auto-ID mobile scanner or device. In some embodiments, this mobile device may be handheld. In another embodiment, the scanner may be substantially fixed in place, as described above.

In one embodiment, the screen 430 may be configured to allow a user to enter a type of good or product being operated upon. In various embodiments, this data may be entered by scanning a barcode or RFID, etc. of the physical object. In various embodiments, the screen or UI element 432 may be configured to facilitate the selection of an action (e.g., move, load, unload, etc.) that is being performed on the scanned object.

In various embodiments, the screen or UI element 434 may be displayed as a result of one or more of the action selections of screen 432. In such an embodiment, the screen 434 may be configured to further describe the action being performed on the scanned object. In various embodiments, this may allow a user to associate the action with the transfer order or another type of operation. In some embodiments, screen or UI element 438 may display the transfer order associated with the object.

FIG. 4e is block diagrams of an example embodiment of a user interface 400 of the planning system in which a user may confirm or check the performance a transfer order. In various embodiments, this may occur before a transfer order is communicated to the execution system, during the performance of the transfer order by the execution system, or after the execution system has reported that the transfer order is completed.

In one embodiment, the UI 400 may include a screen or UI element 430 configured to allow a user to search for a given transfer order. In various embodiments, the UI 400 may also include a screen or UI element 432 configured to display a selected transfer order and the status of that transfer order. In various embodiments, the screen 432 may display the expected number of physical objects at the destination location after the transfer order is completed and the actual number of physical objects at the destination location as of the most recent update from the execution system.

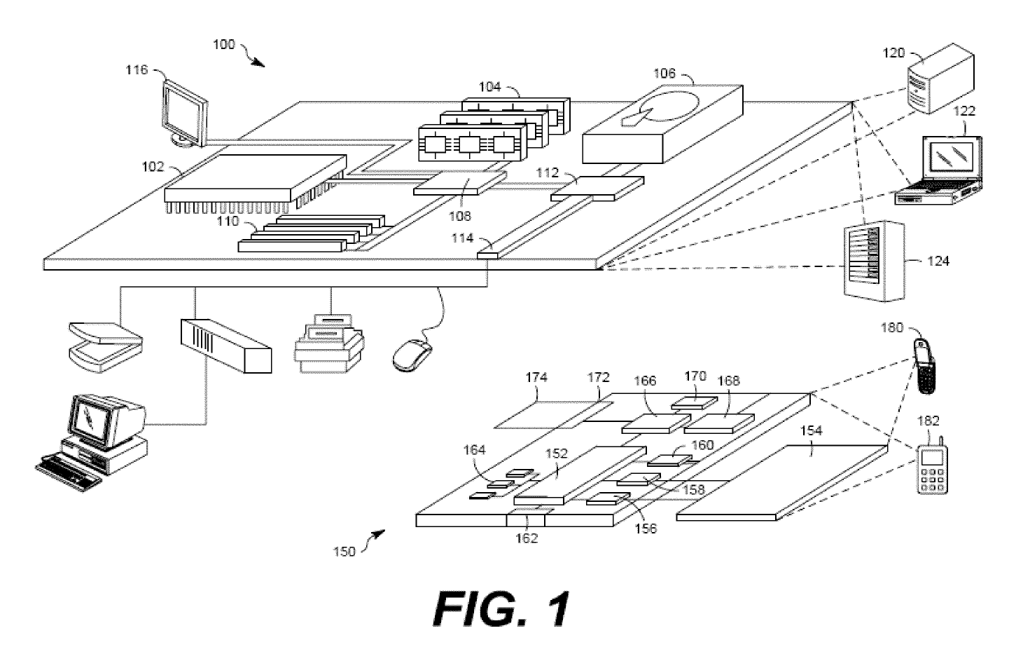

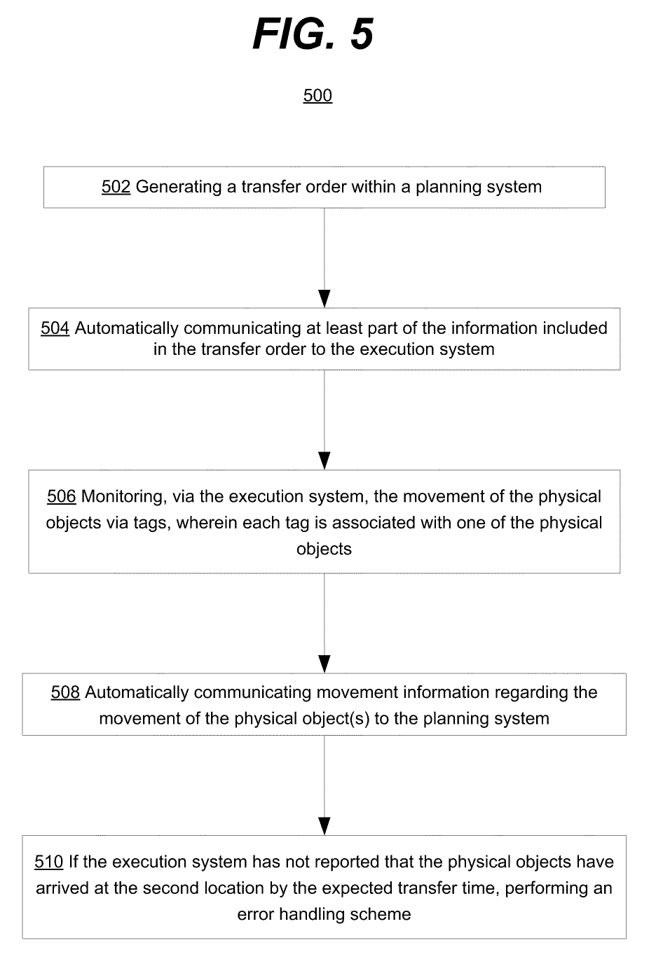

FIG. 5 is a flow chart of an example embodiment of a technique in accordance with the disclosed subject matter. In various embodiments, the technique 500 may be used or produced by the systems such as those of FIG. 1, 2, 3, or 4. Although, it is understood that the above are merely a few illustrative examples to which the disclosed subject matter is not limited. It is understood that the disclosed subject matter is not limited to the ordering of or number of actions illustrated by technique 500.

Block 502 illustrates that, in one embodiment, a transfer order may be generated by or within a planning system, as described above. In one embodiment, generating may include determining a number of the physical objects desired at the second location, based at least in part upon a production schedule, as described above. In some embodiments, generating may also include determining a transfer requirement indicating which physical objects to move from the at least a first location to the second location, as described above. In some embodiments, generating may include converting the transfer requirement to a transfer order, as described above. In various embodiments, one or more of the actions illustrated by this Block may be performed by the apparatuses or systems of FIGS. 1, 2, and 3; the transfer order generator 240 of FIG. 2; or the planning systems of FIG. 2, or 3, as described above.

Block 504 illustrates that, in one embodiment, at least part of the information included in the transfer order may be automatically communicated to the execution system, as described above. In various embodiments, communicating may include communicating the transfer order via an asynchronous communications scheme, as described above. In one embodiment, communicating may include communicating the transfer order via an IDoc format, as described above. In some embodiments, communicating may include mapping a first set of fields and values employed by the planning system to a second set of fields and values employed by the execution system, as described above. In various embodiments, one or more of the actions illustrated by this Block may be performed by the apparatuses or systems of FIGS. 1, 2, and 3; the transfer order generator 240 of FIG. 2; or the planning systems of FIG. 2, or 3, as described above.

Block 506 illustrates that, in one embodiment, the movement of the physical objects may be monitored, via tags, wherein each tag is associated with one of the physical objects, as described above. In various embodiments, monitoring may include authenticating the genuineness of the physical objects, as described above. In some embodiments, monitoring may include converting the received information to an generic document and updating the generic document associated with the transfer order, as described above. In one embodiment, monitoring may include scanning a radio frequency identifier (RFID) tag at a substantially predefined location or event, as described above. In some embodiments, monitoring may include storing the scanned information in the execution system, as described above. In various embodiments, monitoring may include completing the transfer order when the physical objects have been moved to the second location, as described above. In some embodiments, generating may include converting the transfer requirement to a transfer order, as described above. In various embodiments, one or more of the actions illustrated by this Block may be performed by the apparatuses or systems of FIGS. 1, 2, and 3; the transfer order translator 244 or transfer order monitor 246 of FIG. 2; or the execution systems of FIG. 2, or 3, as described above.

Block 508 illustrates that, in one embodiment, movement information regarding the movement of the physical object(s) may be automatically communicated to the planning system, as described above. In one embodiment, communicating may include communicating the movement information via a synchronous communications scheme, as described above. In some embodiments, communicating may include communicating the movement information via a remote procedure or function call, as described above. In another embodiment, communicating may include communicating information when the physical objects have been moved to the second location, as described above. In various embodiments, one or more of the actions illustrated by this Block may be performed by the apparatuses or systems of FIGS. 1, 2, and 3; the transfer order reporter 248 or transfer order monitor 246 of FIG. 2; or the execution systems of FIG. 2, or 3, as described above.

Block 510 illustrates that, in one embodiment, if the execution system has not reported that the physical objects have arrived at the second location by the expected transfer time, an error handling scheme may be performed, as described above. In various embodiments, one or more of the actions illustrated by this Block may be performed by the apparatuses or systems of FIGS. 1, 2, and 3; the transfer order error handler 250 or transfer order reporter 242 of FIG. 2; or the planning or execution systems of FIG. 2, or 3, as described above.

FIG. 1 shows an example of a generic computer device 100 and a generic mobile computer device 150, which may be used with the techniques described here. Computing device 100 is intended to represent various forms of digital computers, such as laptops, desktops, workstations, personal digital assistants, servers, blade servers, mainframes, and other appropriate computers. Computing device 150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 100 includes a processor 102, memory 104, a storage device 106, a high-speed interface 108 connecting to memory 104 and high-speed expansion ports 110, and a low speed interface 112 connecting to low speed bus 114 and storage device 106. Each of the components 102, 104, 106, 108, 110, and 112, are interconnected using various busses, and may be mounted on a common motherboard or in other manners as appropriate. The processor 102 can process instructions for execution within the computing device 100, including instructions stored in the memory 104 or on the storage device 106 to display graphical information for a graphical user interface (GUI) on an external input/output device, such as display 116 coupled to high speed interface 108. In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, or a multi-processor system, etc.).

The memory 104 stores information within the computing device 100. In one implementation, the memory 104 includes a volatile memory unit or units. In another implementation, the memory 104 includes a non-volatile memory unit or units. The memory 104 may also be another form of computer-readable medium, such as a magnetic or optical disk.

The storage device 106 is capable of providing mass storage for the computing device 100. In one implementation, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 104, the storage device 106, or memory on processor 102.

The high speed controller 108 manages bandwidth-intensive operations for the computing device 100, while the low speed controller 112 manages lower bandwidth-intensive operations. Such allocation of functions is exemplary only. In one implementation, the high-speed controller 108 is coupled to memory 104, display 116 (e.g., through a graphics processor or accelerator), and to high-speed expansion ports 110, which may accept various expansion cards (not shown). In the implementation, low-speed controller 112 is coupled to storage device 106 and low-speed expansion port 114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 100 may be implemented in a number of different forms, as shown in the figure. For example, it may be implemented as a standard server 120, or multiple times in a group of such servers. It may also be implemented as part of a rack server system 124. In addition, it may be implemented in a personal computer such as a laptop computer 122. Alternatively, components from computing device 100 may be combined with other components in a mobile device (not shown), such as device 150. Each of such devices may contain one or more of computing device 100, 150, and an entire system may be made up of multiple computing devices 100, 150 communicating with each other.

Computing device 150 includes a processor 152, memory 164, an input/output (I/O) device such as a display 154, a communication interface 166, and a transceiver 168, among other components. The device 150 may also be provided with a storage device, such as a micro-drive or other device, to provide additional storage. Each of the components 150, 152, 164, 154, 166, and 168, are interconnected using various buses, and several of the components may be mounted on a common motherboard or in other manners as appropriate.

The processor 152 can execute instructions within the computing device 150, including instructions stored in the memory 164. The processor may be implemented as a chipset of chips that include separate and multiple analog and digital processors. The processor may provide, for example, for coordination of the other components of the device 150, such as control of user interfaces, applications run by device 150, and wireless communication by device 150.

Processor 152 may communicate with a user through control interface 158 and display interface 156 coupled to a display 154. The display 154 may be, for example, a TFT LCD (Thin-Film-Transistor Liquid Crystal Display) or an OLED (Organic Light Emitting Diode) display, or other appropriate display technology. The display interface 156 may comprise appropriate circuitry for driving the display 154 to present graphical and other information to a user. The control interface 158 may receive commands from a user and convert them for submission to the processor 152. In addition, an external interface 162 may be provide in communication with processor 152, so as to enable near area communication of device 150 with other devices. External interface 162 may provide, for example, for wired communication in some implementations, or for wireless communication in other implementations, and multiple interfaces may also be used.

The memory 164 stores information within the computing device 150. The memory 164 can be implemented as one or more of a computer-readable medium or media, a volatile memory unit or units, or a non-volatile memory unit or units. Expansion memory 174 may also be provided and connected to device 150 through expansion interface 172, which may include, for example, a SIMM (Single In Line Memory Module) card interface. Such expansion memory 174 may provide extra storage space for device 150, or may also store applications or other information for device 150. Specifically, expansion memory 174 may include instructions to carry out or supplement the processes described above, and may include secure information also. Thus, for example, expansion memory 174 may be provide as a security module for device 150, and may be programmed with instructions that permit secure use of device 150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 164, expansion memory 174, or memory on processor 152, that may be received, for example, over transceiver 168 or external interface 162.

Device 150 may communicate wirelessly through communication interface 166, which may include digital signal processing circuitry where necessary. Communication interface 166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 168. In addition, short-range communication may occur, such as using a Bluetooth, WiFi, or other such transceiver (not shown). In addition, GPS (Global Positioning System) receiver module 170 may provide additional navigation- and location-related wireless data to device 150, which may be used as appropriate by applications running on device 150.

Device 150 may also communicate audibly using audio codec 160, which may receive spoken information from a user and convert it to usable digital information. Audio codec 160 may likewise generate audible sound for a user, such as through a speaker, e.g., in a handset of device 150. Such sound may include sound from voice telephone calls, may include recorded sound (e.g., voice messages, music files, etc.) and may also include sound generated by applications operating on device 150.

The computing device 150 may be implemented in a number of different forms, as shown in the figure. For example, it may be implemented as a cellular telephone 180. It may also be implemented as part of a smart phone 182, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosed subject matter.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
generating a transfer order within a planning system,
wherein the transfer order includes instructions for the transfer of at least one physical object from at least a first location to a second location and an expected transfer time;
automatically communicating at least part of the information included in the transfer order to an execution system;
monitoring, via the execution system, the movement of the physical objects via tags, wherein each tag is associated with one of the physical objects; and
automatically communicating movement information regarding the movement of the physical object(s) to the planning system.

2. The method of claim 1, wherein automatically communicating the transfer order to the execution system includes communicating the transfer order via an asynchronous communications scheme.

3. The method of claim 1, wherein automatically communicating information regarding the movement of the physical object(s) to the planning system includes communicating the movement information via a synchronous communications scheme.

4. The method of claim 1, wherein monitoring includes authenticating the genuineness of the physical objects.

5. The method of claim 1, wherein automatically communicating the transfer order to the execution system includes:
mapping a first set of fields and values employed by the planning system to a second set of fields and values employed by the execution system.

6. The method of claim 1, wherein automatically communicating the transfer order to the execution system includes communicating the transfer order via an IDoc format;
wherein monitoring the movement of the physical objects includes updating a generic document associated with the transfer order; and
wherein automatically communicating information regarding the movement of the physical object(s) includes communicating the movement information via a remote procedure call.

7. The method of claim 1, further including:
if the execution system has not reported that the physical objects have arrived at the second location by the expected transfer time, performing an error handling scheme.

8. The method of claim 1, wherein generating a transfer order includes:
based at least in part upon a production schedule, determining a number of the physical objects desired at the second location;
determining a transfer requirement indicating which physical objects to move from the at least a first location to the second location; and
converting the transfer requirement to a transfer order.

9. The method of claim 1, wherein monitoring, via the execution system, the movement of the physical objects via tags associated with the physical objects includes:
scanning a radio frequency identifier (RFID) tag at a substantially predefined location,
storing the scanned information in the execution system, and
completing the transfer order when the physical objects have been moved to the second location; and
wherein automatically communicating movement information includes communicating information when the physical objects have been moved to the second location.

10. A system comprising:
a planning system device configured to:
generate a transfer order, wherein the transfer order includes instructions for the transfer of at least one physical object from at least a first location to a second location and an expected transfer time, and
automatically communicate at least part of the information included in the transfer order to an execution system device; and
the execution system device configured to:
monitor the movement of the physical objects via tags, wherein each tag is associated with one of the physical objects, and
automatically communicate movement information regarding the movement of the physical object(s) to the planning system.

11. The system of claim 10, wherein the planning system device is configured to communicate the transfer order via an asynchronous communications scheme.

12. The system of claim 10, wherein the execution system device is configured to communicate the movement information via a synchronous communications scheme.

13. The system of claim 10, wherein the execution system device is configured to authenticate the genuineness of the physical objects.

14. The system of claim 10, wherein the planning system device is configured to map a first set of fields and values employed by the planning system device to a second set of fields and values employed by the execution system device.

15. The system of claim 10, wherein the planning system device is configured to communicate the transfer order via an IDoc format; and
wherein execution system device is configured to:
convert the received IDOC into a generic document,
update the generic document associated with the transfer order as monitoring events occur, and
communicate the movement information via a remote procedure call.

16. The system of claim 10, wherein the planning system device is configured to, if the execution system has not reported that the physical objects have arrived at the second location by the expected transfer time, perform an error handling scheme.

17. The system of claim 10, wherein the planning system device is configured to:
based at least in part upon a production schedule, determine a number of the physical objects desired at the second location;
determine a transfer requirement indicating which physical objects to move from the at least a first location to the second location; and
convert the transfer requirement to a transfer order.

18. The system of claim 10, wherein the execution system device is configured to:
scan a radio frequency identifier (RFID) tag at a substantially predefined location;
store the scanned information in the execution system device;
complete the transfer order when the physical objects have been moved to the second location; and
communicate information when the physical objects have been moved to the second location.

19. A computer program product for managing business information, the computer program product being tangibly embodied on a computer-readable medium and including executable code that, when executed, is configured to cause a planning apparatus to:
generate a transfer order, wherein the transfer order includes instructions for the transfer of at least one physical object from at least a first location to a second location and an expected transfer time;
automatically communicate at least part of the information included in the transfer order to an execution system;
cause the execution system to monitor the movement of the physical objects via tags, wherein each tag is associated with one of the physical objects; and
cause the execution system to automatically to communicate movement information regarding the movement of the physical object(s) to the planning system.

20. The computer program product of claim 19, wherein the code, when executed, causes the planning apparatus to:
communicate the transfer order via an IDoc format; and
receive a communication regarding the movement information via a remote procedure call.
